(19) United States
(12) Patent Application Publication
(10) Pub. No.: US 2008/0052092 A1
(43) Pub. Date: Feb. 28, 2008

(54) A METHOD FOR USE WITH A WEDDING DRESS

(76) Inventor: Carol A. Cleary, Orlando, FL (US)

Correspondence Address: Oppedahl Patent Law Firm LLC, P.O. BOX 4850, FRISCO, CO, 80443-4850, US

(21) Appl. No.: 11/466,294

(22) Filed: Aug. 22, 2006

(51) Int. Cl. G06Q 10/00; G06Q 30/00

(52) U.S. Cl. 705/1

(57) ABSTRACT

There is a great need for an approach to facilitate hair and makeup preparations and selection and purchase of accessories, despite the unavailability a wedding dress. The methods of the current invention present a solution though the use of a substantially similar stand-in for the top portion of a wedding gown. This stand-in hereafter will be referred to as the portable practice garment (PPG). One embodiment of the current invention is a method for selling a wedding dress that includes also selling a PPG that is substantially similar to the top portion of the dress. Another embodiment of the invention is a method of selling wedding dresses to retailers that includes also selling PPGs that are substantially similar to the top portions of the dresses. Another embodiment of the invention is a method of selling wedding dresses to brides-to-be that includes selling a PPG that is substantially similar to the top portion of the dress. A bride-to-be then can use the PPG as she decides on hair and makeup as well as what jewelry would best coordinate with her dress style.

### BACKGROUND

Signaled by the familiar notes of Wagner's Bridal Chorus, or a sudden fanfare of Clarke's Trumpet Voluntary, the guests rise and all eyes are focused on the back of the room. This is the moment the fairy tale that little girls dream of comes true. It is the beginning of “happily ever after”.

Whether she is wearing a chic and sophisticated silk sheath or an extravagant Cinderella-like ball gown, the moment a bride makes her entrance is often the most beautiful moment in her life. This moment does not happen because the bride opened her closet door, threw on the first thing she could find, and pulled her hair back in a scrunchy. In most cases, it takes many weeks or even months of preparation.

Why does it take so long to prepare for such a brief moment? Most would agree that it is all about the dress. The bride's first step is not down the aisle, but is instead into a bridal salon. After trying on several gowns, oohing and aahing, and maybe even shedding a sentimental tear or two, the “perfect” dress is finally selected. Once the dress is picked, that is just the beginning. The bride still needs a veil or other hairpiece. She needs to decide on shoes. She needs to select the ideal pieces of jewelry to coordinate with the dress. She needs to decide on a hairstyle, and most likely have her hair dresser practice the style to make sure that it is “just right.” She needs to find undergarments that will make everything lie smoothly without being visible. She may also want to make sure that her makeup will perfectly coordinate with the fabric of the dress, and make sure that she doesn't have any strange looking tan lines.

One of the problems that many brides encounter after selecting the “perfect” dress is that it may be months before she is actually able to take the dress home. This can make the preparing and purchasing of all of the items that go along with the dress difficult, as the dress can not easily be brought along to coordinate things. It may even be the case that the bride purchases her dress in one geographical location while living in another location, possibly not even the same state. In that case while she gathers the other items, she wouldn't even be able to “visit” her dress or a sample show room dress to make sure things truly coordinate. In addition, even if the bride is able to “possess” her dress well before the wedding day, most gowns are extremely impractical to transport from shop to shop. It would also be ridiculous to imagine the bride-to-be in her actual bridal gown during a practice hair and make-up session weeks before the wedding, or wearing the gown in a tanning booth. What if the gown got dirty, torn, or even lost, while it was hauled around from place to place?

Therefore, there is a great need for an approach to facilitate hair and makeup preparations and selection and purchase of accessories, despite the unavailability of the wedding dress and, even if it is available, despite the risk of damage or loss to the wedding dress. The approach would need to be workable soon after the dress was selected and would need to be consistent with problems of distance.

During the time a bride-to-be is in the process of selecting her dress, she may visit several different competing dress stores. In most cases, they offer the same sort of service. They present a rack of sample dresses. After the bride-to-be selects a dress, they prepare an order for the dress in the bride-to-be's size. The chief differences between one store to the next, is the selection of dresses available as samples, the accessories the store carries, and whether or not seamstress services are available onsite. Therefore, it would be appealing to dress shop owners to find a new and creative way to attract potential buyers to buy a dress at their shop instead of at their competitors. A possible attraction could be to offer a special accessory, that every bride-to-be feels she needs, as a part of the sales process.

### SUMMARY OF THE INVENTION

The methods of the current invention present solutions to both issues though the use of a substantially similar stand-in for the top portion of a wedding gown. This stand-in hereafter will be referred to as the portable practice garment (PPG).

Although not necessarily identical, the design of the PPG's neckline and sleeves is modeled after that of the wedding dress itself. The PPG's fabric may have a similar color, texture, weight, and sheen in comparison to the dress it is modeled after. While wedding dresses can cost hundreds or even thousands of dollars, the PPG is usually much more economical. Its portability is due to its size which ranges from that of a strapless bustier to that of a long sleeve shirt.

The PPG would greatly benefit store owners if they were able to offer the product to entice a bride-to-be to purchase the “perfect dress” with its associated PPG from their stores as opposed to the competition down the street or in another town that didn't offer such a helpful accessory. Therefore, one embodiment of the current invention is a method for selling a wedding dress that includes also selling a PPG that is substantially similar to the top portion of the dress.

The PPG would greatly benefit dress designers and manufactures if they were able to offer the product to entice retailers to market their dresses instead of those of their competitors who sell dresses without associated PPGs. Therefore another embodiment of the invention is a method of selling wedding dresses to retailers that includes also selling PPGs that are substantially similar to the top portions of the dresses.

Above all, the PPG would greatly benefit the bride-to-be who is striving to be her most beautiful at that magic moment she begins her walk down the aisle. Therefore another embodiment of the invention is a method of selling wedding dresses to brides-to-be that includes selling a PPG that is substantially similar to the top portion of the dress. A bride-to-be then can use the PPG as she decides on hair and makeup as well as what jewelry would best coordinate with her dress style.

### BRIEF DESCRIPTION OF THE DRAWINGS

FIG. 1 is an illustration of one embodiment of a halter styled PPG

FIG. 2 is an illustration of one embodiment of a strapless sweet-heart neckline PPG

FIG. 3 is an illustration of one embodiment of a strapless PPG

FIG. 4 is an illustration of one embodiment of a PPG having straps that may or may not be removable.

### DETAILED DESCRIPTION

The central item associated with all methods of the current invention is referred to in this application as the portable practice garment (PPG). The PPG is an article of clothing to be used by brides-to-be. It is for the most part a “stand in” for a wedding dress, to be used for a variety of purposes. The list of uses for the PPG includes but is not limited to:
selecting jewelry,
practicing hairstyles,
trying different makeup techniques,
selecting a veil or other hairpiece,
achieving a perfect tan line to coordinate with the actual wedding dress,
having a fun garment to wear to social gatherings such as bachelorette parties.

One reason that it is so useful is that it is a substitute for the top portion of the wedding dress only. This means that the PPG does not extend to a length much further than a few inches below what is known in the industry as the “natural” waistline of the person wearing it.

If a bride were extremely particular and did not have any concerns about cost, it is possible that the PPG would be custom made to be identical to the top portion of her wedding dress including the same neck and sleeve line as well as being created with the same fabric and any lace or beading used on the dress itself. However, it would be more likely that a cost effective and faster approach would instead be used to create and manufacture the PPG for the mass market. For example, a line including several PPGs might be created having only a small number of neckline styles, a universal bodice (possibly with a lace-up back), and detachable straps or sleeves.

PPGs may be constructed of any appropriate dressmaking material including but not limited to silk, satin, taffeta, cotton, rayon, charmeuse, velvet or lace. PPGs may or may not have decorative beading. The fabric may or may not be washable.

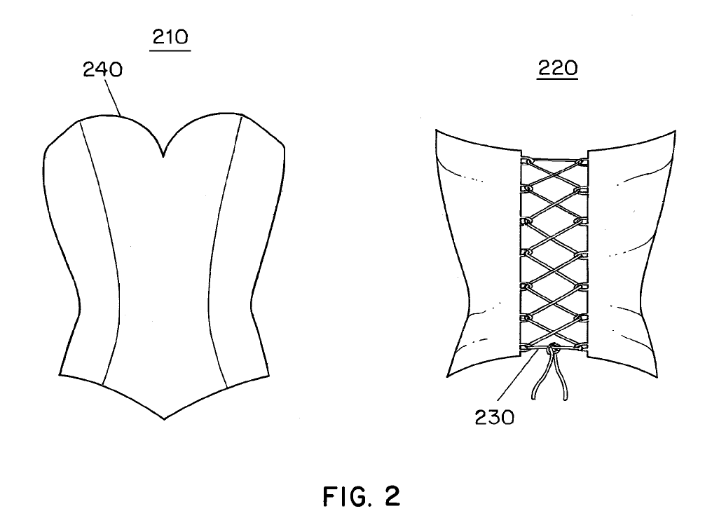

In order to make it easier for one particular size and style of a PPG to fit multiple figures, one embodiment as illustrated in FIG. 2 has a “corset” styled back (220), meaning that it contains cris-crossed laces (230) which can be tightened until the garment fits the body of the person wearing it. PPGs used in the methods of the current invention are not necessarily limited to this laced style, but could also utilize side or back zippers, buttons, hooks, velcro, or other appropriate means to close any gaps or separations. It would also not be unusual for PPGs to be able to fit over the wearer's head without having to first open or enlarge it, thus having no need for zippers, laces, hooks, or other fasteners.

There are various combinations of neck and sleeve lines that distinguish the style of the top portion of a wedding dress and corresponding combinations would be used for associated PPGs.

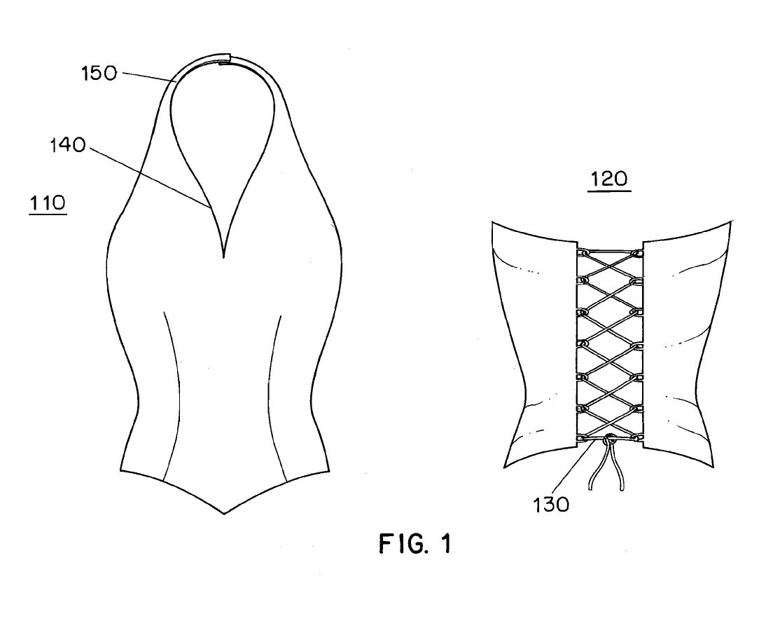

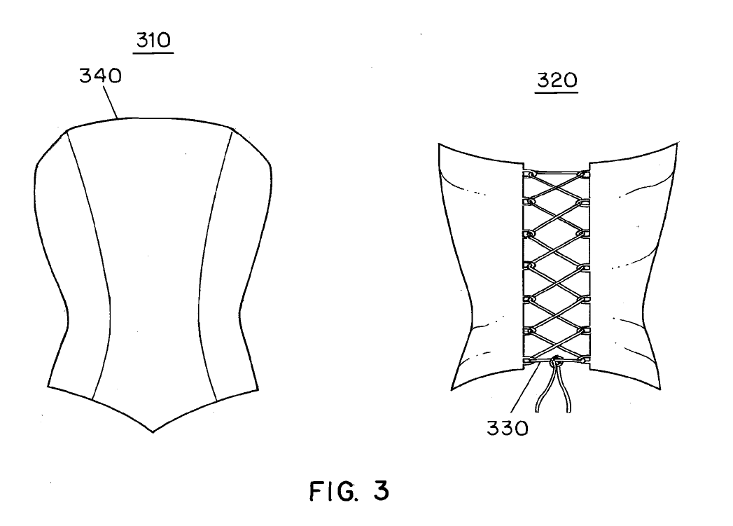

Exemplary necklines include but are not limited to:
A plunging v-neck or scalloped v-neck (see FIG. 1, part 140)
A sweat-heart neckline (see FIG. 2, part 240)
Ballerina rounded neckline
Straight horizontal neckline (see FIG. 3, part 340)
Key-hole neckline

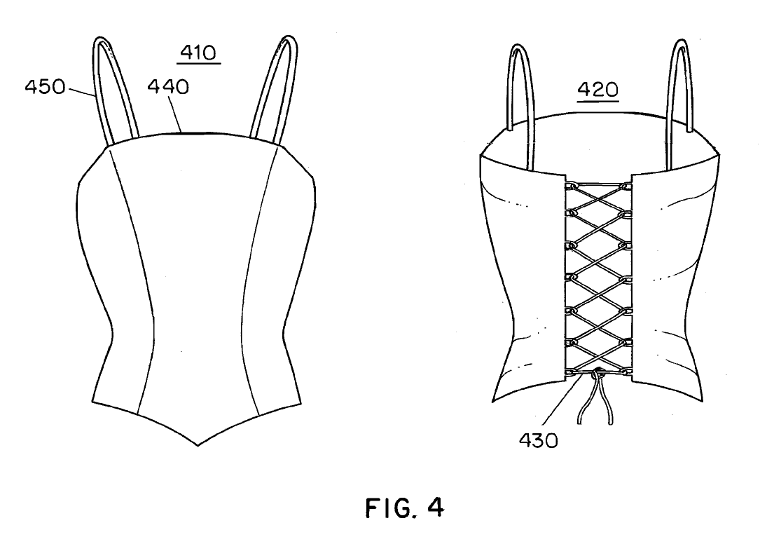

Exemplary sleeve lines include but are not limited to:
Strapless (see FIG. 2 and FIG. 3
Halter (see FIG. 1)
Spaghetti Straps (see FIG. 4)
Capped sleeves
Short sleeves
Long sleeves

Two embodiments of the current invention are methods for buying and selling wedding dresses and include steps which involve the PPG. Other embodiments of the invention include the bride using the PPG to ensure a successful look on her wedding day, for instance, by wearing it as she experiments with different hairstyles. During the time she practices and perfects her look, the PPG also allows the bride to feel “bride-like” for a longer period of time. Just for fun, the PPG can be an additional accessory that the bride could wear to her bachelorette party. Currently, the only item that identifies a bride-to-be at her bachelorette party is a veil.

An embodiment of the invention may bring more customers into a particular dress shop. It is a method of selling a wedding dress. This method includes but is not necessarily limited to the following steps. The shop offers a selection of wedding dress styles. The dresses may be short or long; sleeveless, short sleeved, long sleeved or with spaghetti straps; v-necked, high necked, swoop necked, etc.; and made with a wide variety of fabrics and trims. An agent of the shop completes an agreement to sell a wedding dress. The dress has a top portion with a length not extending beyond six inches below the waistline of someone wearing the dress. For the purposes of this invention, the term waistline means the natural waistline as known in the dress making industry. The top portion of the dress has a particular style due to its specific combination of sleeve and neck design as described above. This agreement to sell the dress is made at a particular time, usually well in advance of the purchaser receiving the actual dress. During the process of selling the dress, a PPG with a similar style to the top portion of the dress is also offered for sale. In some cases, a dress shop might even offer a promotion of a free or discounted PPG with the purchase of a dress from that particular shop. The shop might have PPGs available immediately at the time of ordering the dress, or the purchaser may have to wait to receive one. Ideally, several PPGs each having different combinations of the typical neck and sleeve lines found on the dresses sold at the store would always be available. The key is to offer a PPG that has a style very similar to that of the wedding dress purchased, so that it will be a good “stand-in” for the dress itself. The PPG has a length that extends no more than six inches past the waistline of an individual wearing the PPG. Another step in this embodiment of the invention is the completion of an agreement to sell the PPG. The wedding dress will be made available no sooner than one week after the time of the agreement to sell the wedding dress. The PPG would be available either immediately, at some time before the wedding dress becomes available, at the same time the dress becomes available, or after the wedding dress becomes available.

Another embodiment of the current invention assists the bride with looking her best on her wedding day. It is a method of purchasing a wedding dress. The method includes but is not limited to the following steps. In most cases, before she begins looking for a wedding dress, the bride becomes engaged to be married. Next she starts shopping for a wedding dress at one or more stores. Sometimes the stores are in different towns as well. Finally, she selects a wedding dress. The wedding dress has a top portion that extends no more than six inches below the natural waistline. The top portion has a particular style associated with it. Although not the only ones, two of the more noticeable items associated with the dress style are the sleeve design and neck line. At one point in time an agreement to buy the wedding dress is completed. At another time or at the same time a second agreement to purchase a PPG is made. The PPG has a style substantially similar to the style associated with the top portion of the wedding dress. This does not necessarily mean identical, but similar enough that the PPG would make a good stand in while the bride practices different hair styles and selects coordinating jewelry that would look nice with the neckline of the actual dress. The PPG has a length no longer than six inches below a waistline of a person wearing the PPG. In this embodiment of the invention, The wedding dress is received or possessed by the bride no sooner than one week after the time of the agreement to purchase the wedding dress. The bride will be able to possess the PPG at the time the agreement is made to purchase the wedding dress, before the wedding dress is possessed, at the same time the wedding dress is possessed, or after the wedding dress comes into the bride's possession. The bride may wear the PPG while she selects a piece of jewelry, preferably a coordinating one. The bride may wear the PPG while she selects or practices a hair style. The bride may wear the PPG while she selects a veil. As mentioned above, the bride may also wear the PPG while she attends social gatherings such as bachelorette parties. The bride might even want to save the PPG as a memento. People could sign their names on it at her bachelorette party.

Another embodiment of the invention may be used to entice retailers to purchase from particular vendors. This embodiment is a method of supplying wedding dresses to retailers. The method includes but is not limited to the following steps. A vendor offers a selection of wedding dress styles. As with other embodiments of the invention, each wedding dress has a top portion and a style associated with the top portion. The top portion has a length that extends no farther than six inches below the waistline of a person wearing the wedding dress. The vendor completes an agreement to supply a wedding dress to a retailer. The vender also offers to sell a PPG with a style (as described in other embodiments) that is substantially similar to the top portion of the wedding dress. As with other embodiments, the PPG has a length that extends no longer than six inches below a waist of an individual wearing the PPG. The vendor completes an agreement to sell the PPG. The wedding dress becomes available to the retailer at least one week after the time of the agreement of the vendor to supply the dress. A vendor may decide to make the PPG be at no further cost to the retailer than the dress. The vendor may also discount the price of the PPG if a dress is purchased. The vendor might also make several PPGs available to the retailer, whether or not the retailer has purchased a dresses that coordinate with the PPGs.

Turning now to a description of the figures. FIG. 1 is an illustration of a halter style of a PPG. The front of the PPG is part number 110. The back of the PPG is part number 120. The halter straps (150) surround the neck of the person wearing it. The neckline (140) in this figure is shown to be a deep V. Necklines associated with the halter top style are not limited to a deep V. For example, the neckline could also be a more shallow V, could be circular, could be straight across, or could be many other styles. The back (120) of the PPG illustrated by FIG. 1 shows laces (130) which can be adjusted to allow the PPG to fit many different sizes of people. As discussed above, there are options other than the corset-like laces available.

FIG. 2 is an illustration of a strapless style of a PPG. The front of the PPG is part number 210.

The back of the PPG is part number 220. The neckline (240) in this figure appears to be a sweet-heart style. Necklines associated with this strapless style are not limited to the sweet-heart. For example, as illustrated in FIG. 3 the neckline (340) could be straight across. The neckline could also be other styles as well. The back of the PPG (220 and 320) illustrated by FIG. 2 and FIG. 3 shows laces (230 and 330) which can be adjusted to allow the PPG to fit many different sizes of people. As discussed above, there are options other than the corset-like laces available.

FIG. 4 is an illustration of a PPG that has straps (450). These straps may be removable. The neckline (440) of this PPG appears to be straight across. As described above, the neckline could be a different design, such as a v-neck or sweet-heart, or other designs as well. The back of the PPG (420) illustrated by FIG. 4 laces (430) which can be adjusted to allow the PPG to fit many different sizes of people. As discussed above, there are options other than the corset-like laces available.

Those skilled in the art will have no difficulty devising myriad obvious variations and improvements upon the invention without departing from its teachings, all of which variations and improvements are intended to be encompassed by the claims which follow.

It also should be appreciated, that the methods of this invention could be practiced with the sale or purchase of other special occasion dresses. For example, a homecoming queen candidate or someone nominated for an Oscar, might also want to practice the methods of the invention to make sure that her appearance is as flawless as possible when the big moment arrives.

1. A method of selling a wedding dress comprising the steps of:
offering a selection of wedding dress styles;
completing an agreement to sell a wedding dress, said wedding dress having a top portion and a first particular style associated with said top portion, said top portion having a length, said length extending no farther than 6 inches below a waist of a person wearing the wedding dress, said agreement occurring at a time;
offering to sell a portable practice garment (PPG), said PPG having a second particular style substantially similar to the first particular style associated with the top portion of the wedding dress, said PPG having a length, said length capable of extending no more than six inches past a waist of an individual wearing the PPG;
completing an agreement to sell the portable practice garment (PPG);
no sooner than one week after the time of the agreement to sell the wedding dress, making the wedding dress available;
making the PPG available at a second time.

2. The method of claim 1 further characterized in that the second time at which the PPG becomes available is at the same time the agreement to sell the wedding dress occurs.

3. The method of claim 1 further characterized in that the second time at which the PPG becomes available is at a later time than time the agreement to sell the wedding dress occurs.

4. The method of claim 1 further characterized in that the second time at which the PPG becomes available is at a time prior to the time the agreement to sell the wedding dress occurs.

5. The method of claim 1 further characterized in that the second time at which the PPG becomes available is prior to the time the wedding dress becomes available.

6. The method of claim 1 further characterized in that the agreement to sell the PPG includes free offer of the PPG with the wedding dress the top of which it is associated.

7. A method of purchasing a wedding dress comprising the steps of:
becoming engaged to be married;
shopping for a wedding dress in at least one store;
selecting a wedding dress, said wedding dress having a top portion and a first particular style associated with said top portion, said top portion having a length, said length extending no farther than 6 inches below a waist of a person wearing the wedding dress;
completing an agreement to buy the wedding dress, said agreement occurring at a time;
completing an agreement to purchase a portable practice garment (PPG), said PPG having a second particular style substantially similar to the first particular style associated with the top portion of the wedding dress, said PPG having a length, said length being no longer than six inches below a waist of a person wearing the PPG;
no sooner than one week after the time of the agreement to purchase the wedding dress, possessing the dress
possessing the PPG at a second time.

8. The method of claim 7 further comprising the step of having a waist and wearing the PPG, wherein the PPG has a length, said length not extending more than six inches below the waist.

9. The method of claim 7 further characterized in that the second time at which the PPG is possessed is at the same time the agreement to buy the wedding dress occurs.

10. The method of claim 7 further characterized in that the second time at which the PPG is possessed is at a later time than time the agreement to sell the wedding dress occurs.

11. The method of claim 7 further characterized in that the second time at which the PPG is possessed is at a time prior to the time the agreement to sell the wedding dress occurs.

12. The method of claim 7 further characterized in that the second time at which the PPG is possessed is prior to the time the wedding dress is possessed.

13. The method of claim 7 further comprising the step of wearing the PPG and selecting a piece of jewelry.

14. The method of claim 7 further comprising the step of wearing the PPG and selecting a hair style.

15. The method of claim 7 further comprising the step of wearing the PPG and selecting a veil.

16. The method of claim 7 further comprising the step of wearing the PPG and attending a social gathering.

17. A method of supplying wedding dresses to retailers, the method of comprising the steps of:
offering a selection of wedding dress styles, each wedding dress having a top portion and a first particular style associated with said top portion, said top portion having a length, said length extending no farther than six inches below a waist of a person wearing the wedding dress;
completing an agreement to supply a first wedding dress to a retailer;
offering to sell a first portable practice garment (PPG), said PPG having a second particular style substantially similar to the top portion of the first wedding dress, said PPG having a length, said length being no longer than six inches below a waist of an individual wearing the PPG;
completing an agreement to sell the first portable practice garment (PPG);
no sooner than one week after the time of the agreement to sell the first wedding dress, making the wedding dress available to the retailer.
